(19) United States
(12) Patent Application Publication
(10) Pub. No.: US 2012/0124911 A1
(43) Pub. Date: May 24, 2012

(54) SURFACE-MOUNTED WINDOW OPENING LIMIT DEVICE AND METHOD OF USE

(76) Inventors: Bruce Hagemeyer, Pella, IA (US); Dan Raap, Hartford, SD (US); Gary Newman, Valley Springs, SD (US)

(21) Appl. No.: 13/300,260

(22) Filed: Nov. 18, 2011

Related U.S. Application Data
(60) Provisional application No. 61/415,745, filed on Nov. 19, 2010.

(51) Int. Cl. E05B 65/08; E06B 3/44; B32B 37/12; E05C 3/16

(52) U.S. Cl. 49/394; 292/210; 292/228; 292/202; 156/60

(57) ABSTRACT

A window opening limit device includes a substantially planar base and a sash stop pivotally engaged with the base between a first stop position and a second stop position. The sash stop is adapted to pivot about a first axis substantially parallel to the planar base. A catch is pivotally engaged with the base between a first catch position and a second catch position, and is adapted to pivot about a second axis substantially perpendicular to the planar base. When in the first catch position, the catch is engaged with the sash stop, and when in the second catch position, the catch is disengaged from the sash stop.

### CROSS-REFERENCE TO RELATED APPLICATIONS

This application claims priority to and the benefit of U.S. Provisional Patent Application Ser. No. 61/415,745, filed Nov. 19, 2010, entitled “Surface-Mounted Window Opening Limit Device and Method of Use,” the disclosure of which is hereby incorporated by reference herein in its entirety.

### INTRODUCTION

The distance a window may open may be limited by the use of a window opening limit device (WOLD). These WOLDs typically are installed in one window sash of a double hung window (or other sliding window) and project from the window sash when activated. As the opposite window sash is opened, the WOLD limits the distance of the opening, either for safety (to prevent inadvertent egress of a child) and/or security (to prevent an intruder from gaining access). Once a WOLD is deactivated, the window may be opened completely; however, the WOLD remains deactivated until reset by an action on the part of a user, even if the window is subsequently closed.

Recently, changes in building codes have required enhancements for WOLDs. For example, ASTM International has released Standard F2090-10, entitled “Standard Specification for Window Fall Prevention Devices with Emergency Escape (Egress) Release Mechanisms,” the disclosure of which is hereby incorporated by reference herein in its entirety. Among other requirements, this standard requires that a WOLD automatically resets when a window is moved to a closed position, withstand forces to prevent inadvertent egress or active intrusion, and allow a disabled user to disengage a WOLD using a single hand.

Although WOLDs meeting the above-referenced ASTM Standard F2090-10 may be installed in newly-manufactured windows, existing windows may not include compliant devices. Since installation of WOLDs typically involves cutting a frame and/or sash of a window, such installation is best left to window manufacturers. However, safety concerns may necessitate installing WOLDs (either ASTM Standard F2090-10 compliant or otherwise), on a window that has already been manufactured or installed.

### SUMMARY

In one aspect, the technology relates to a window opening limit device including: a substantially planar base; a sash stop pivotally engaged with the base between a first stop position and a second stop position, wherein the sash stop is adapted to pivot about a first axis substantially parallel to the base; and a catch pivotally engaged with the base between a first catch position and a second catch position, wherein the sash stop is adapted to pivot about a second axis substantially perpendicular to the base, and wherein when in the first catch position, the catch is engaged with the sash stop, and wherein when in the second catch position, the catch is disengaged from the sash stop. In an embodiment, the device includes a spring for biasing the sash stop towards the second stop position. In another embodiment, when in the second stop position, the sash stop is oriented substantially perpendicular to the base. In yet another embodiment, when in the second stop position, the sash stop is oriented at an angle to the base. In still another embodiment, when in the first stop position, the sash stop is oriented substantially parallel to the base. In another embodiment, the device includes an adhesive secured to a side of the base opposite the catch. In another embodiment, the catch includes a bumper adapted to pivot the catch from the first catch position to the second catch position, in response to a force exerted against the bumper.

In another aspect, the technology relates to a window opening limit device including: a substantially planar base; a sash stop pivotally engaged with the planar base between a first stop position and a second stop position; and an adhesive element secured to a side of the base opposite the stop. In an embodiment, when in the second stop position, the sash stop is oriented substantially perpendicular to the base. In another embodiment, when in the second stop position, the sash stop is oriented at an angle to the base. In yet another embodiment, the device includes a catch pivotally engaged with the base and adapted to releasably secure the sash stop in the first stop position when the catch is in a first catch position. In still another embodiment, the catch is adapted to disengage from the sash stop when the catch is in a second catch position. In another embodiment, when in the first catch position and the second catch position, the catch is substantially parallel to the base. In another embodiment, the device includes a spring for biasing the stop towards the second stop position.

In another aspect, the technology relates to a window including: a first sash having a pane of glass and a sash frame at least partially surrounding the pane of glass; and a window opening limit device secured to the pane of glass. In an embodiment, the window opening limit device includes: a substantially planar base; a sash stop pivotally engaged with the planar base between a first stop position substantially parallel to the base and a second stop position; and an adhesive element secured to a side of the base opposite the stop, wherein the adhesive element is secured to the pane of glass. In another embodiment, the window opening limit device further includes: a catch pivotally engaged with the base and adapted to releasably secure the sash stop in the first stop position when the catch is in a first catch position. In yet another embodiment, the window includes a second sash slidably movable relative to the first sash, wherein when the sash stop is in the second stop position, the second sash is substantially prevented from movement relative to the first sash.

In another aspect, the technology relates to s method of mounting a window opening limit device to a window sash having a pane of glass, the method including adhering the window opening limit device to the pane of glass. In an embodiment, the window opening limit device includes: a substantially planar base; a sash stop pivotally engaged with the base between a first stop position and a second stop position; and an adhesive element secured to a side of the base opposite the stop, wherein the adhesive element secures the base to the pane of glass.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1A is a front perspective view of a window opening limit device in a stop position.

FIG. 1B is a front perspective view of the window opening limit device of FIG. 1A in a bypass position.

FIG. 1C is a front perspective view of the window opening limit device of FIG. 1A in a maximum pivoted position.

FIG. 1D is an exploded front perspective view of the window opening limit device of FIG. 1A.

FIG. 2A is a partial front perspective view of a window having a window sash in a closed range and a window opening limit device in an extended position.

FIG. 2B is a partial front perspective view of the window of FIG. 2A having the window sash in a limited position and the window opening limit device in the extended position.

FIG. 2C is a partial front perspective view of the window of FIG. 2A having the window sash in the closed range and the window opening limit device in a bypass position.

FIG. 2D is a partial front perspective view of the window of FIG. 2A having the window sash in an open range and the window opening limit device in the bypass position.

FIG. 2E is a partial front perspective view of the window of FIG. 2A having the window sash in the open range and the window opening limit device in a maximum pivoted position.

FIG. 3 depicts a schematic side view of the range of motion of a window having a window opening limit device.

FIGS. 4A-4C are side perspective views of a window opening limit device in a stop position, a bypass position, and a reset position, respectively.

### DETAILED DESCRIPTION

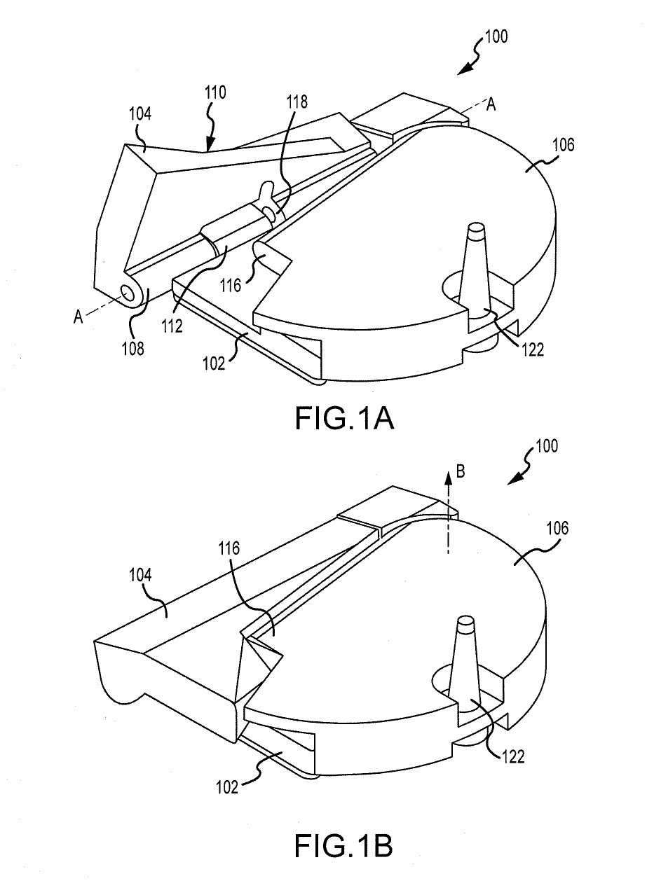

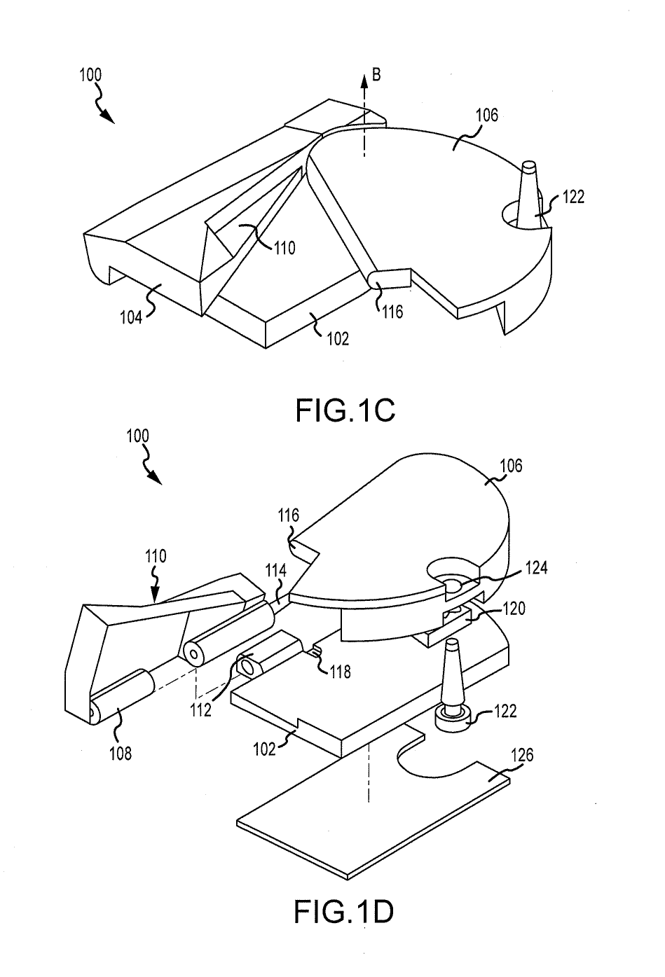

FIGS. 1A-1D depicts one embodiment of a window opening limit device (WOLD) 100. The WOLD 100 includes a substantially planar base 102 to which a stop 104 and a catch 106 are pivotally secured. The stop 104 includes a stop hinge 108 and has a grooved, tapered, or otherwise contoured surface recess 110 along a pitched surface of the stop 104. The stop hinge 108 mates with a corresponding base hinge 112 and allows for a pivotal connection between the stop 104 and the base 102. A hinge pin 114 extending through the stop hinge 108 and the base hinge 112 defines an axis A substantially parallel to the planar base 102 around which the stop 104 pivots. The surface recess 110 allows a window sash to pivot the stop 104 out of an extended position (i.e., a first stop position) as a window sash is lowered, as described below. Additionally, the surface recess 110 mates with a projection 116 on the catch 106. A spring that may fit within a spring recess 118 (formed on either or both of the base 102 and the stop 104) biases the stop 104 toward the extended position, where the stop 104 projects at an angle substantially perpendicular to the base 102 (as depicted in FIG. 1A). In other embodiments, the extended position may be at any angle to the base 102 sufficient to place the stop 104 within a path of travel of the window sash. The spring may be a coil spring or leaf spring, and in certain embodiments, may fit around the hinge pin 114.

The catch 106 is oriented substantially parallel to and is pivotally engaged with the base 102 via a post and receiver 120 connection. The receiver 120 may be secured to the base 102 with fasteners or chemical adhesives or formed or machined such that it is integral with the base 102. In other embodiments, the receiver may not be present and the base itself may be formed as a receiver. The receiver 120 defines an opening for receipt of a pivot post that projects from a rear of the catch 106. The post defines an axis B (as depicted in FIG. 1C) that is substantially perpendicular to the base 102 and around which the catch 106 pivots. The catch 106 also includes a bumper 122 for rotating the catch 106, as described below. The bumper 122 may be formed of a flexible material and secured to the catch 106. In the depicted embodiment, the bumper 122 extends through an opening 124 defined by the catch 106. Since the bumper 122 contacts a surface of a window sash and deflects during use, it may be desirable that the bumper 122 be removable from the catch 106. In that case, damaged bumpers may be replaced easily. The catch 106 also includes the projection 116 configured so as to mate with the surface recess 110 when the stop 104 is in a retracted position (i.e., a second stop position). When in the retracted position, the stop 104 is substantially parallel to the base 102 (as depicted in FIG. 1B).

An adhesive element 126 is secured to a rear surface of the base 102 opposite the catch 106 and stop 104. The adhesive element 126 may be a double-sided bonding tape or may be extruded or otherwise formed directly on the rear of the base 102. When packaged for sale or shipment, a release paper may be secured to the adhesive element 126 to prevent inadvertent adhesion of the WOLD 100 to other surfaces. Adhesives that display desirable adhesion to glass or other surfaces and that may be used in conjunction with the WOLD of the present technology include VHB™ Tape and other high bond-strength tapes and adhesives, manufactured by 3M, DuPont, and other adhesive manufacturing companies. Other fastening means may be used to secure the WOLD to a window frame, window sash, or pane of glass. For example, the base may define on or more openings to receive one or more screws or other mechanical fasteners. Alternatively, one or more integral projections may extend from a rear surface of the base and be configured to engage with one or more holes that may be drilled into a window sash or frame.

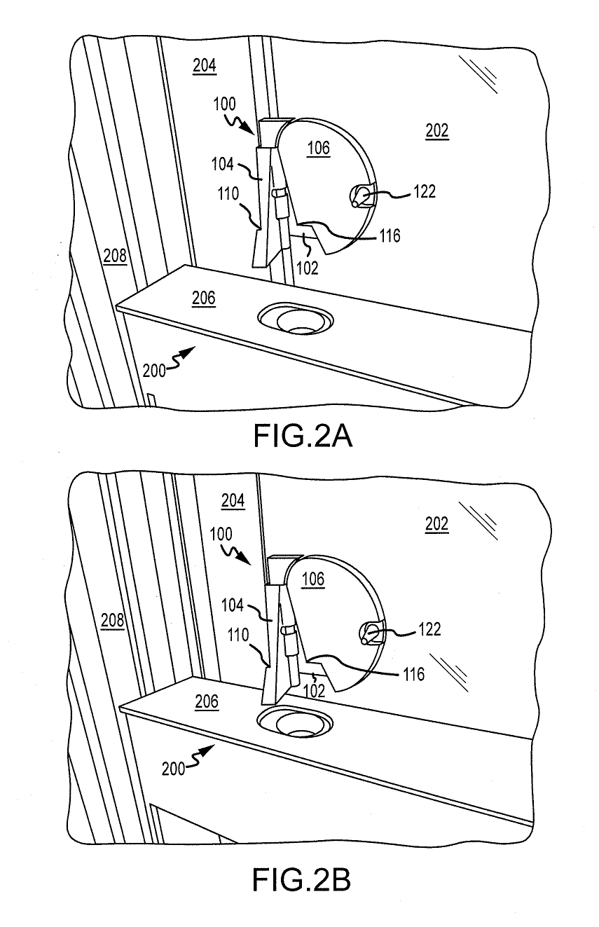

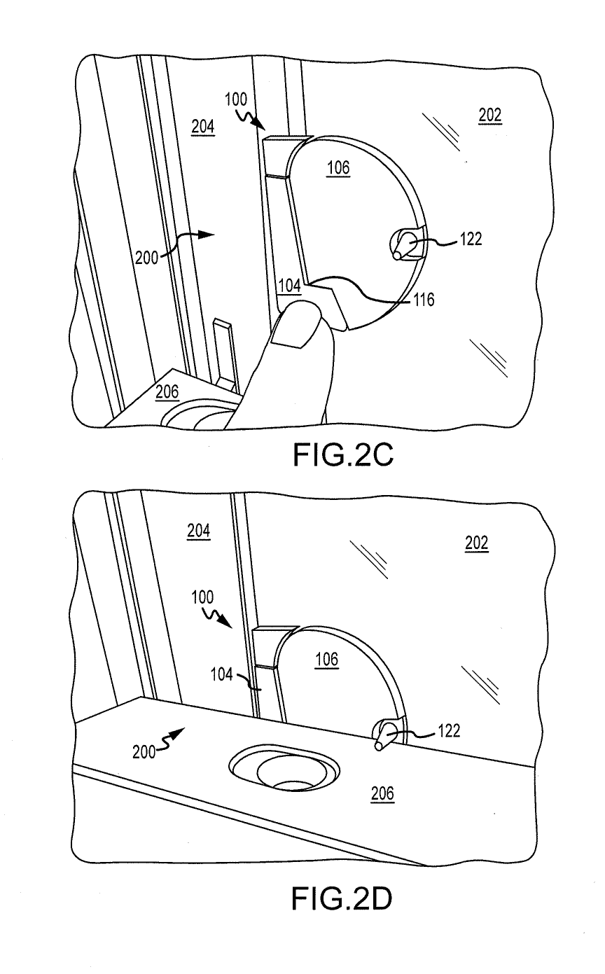

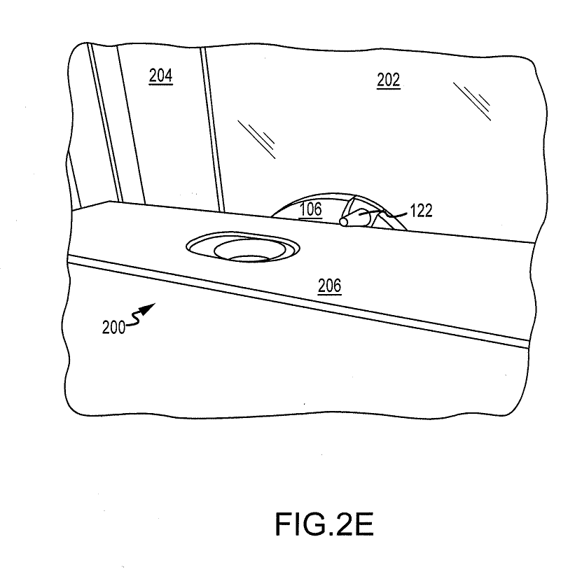

FIGS. 2A-2E depicts a window 200 including a WOLD 100. In the following paragraphs, the operation of the WOLD will be described using the terms upper sash and lower sash, as typical in a double-hung window installation. Additionally, the description below contemplates the WOLD being adhered to a glass pane of a window sash. Regardless, the description below is for illustrative purposes only. A person of skill in the art will understand, based on the description provided herein, the operation of a WOLD adhered or otherwise secured to a window frame or to a window sash, or as used in a single-hung window. Additionally, the WOLD described herein may be used in conjunction with window sashes that slide horizontally, instead of vertically, as depicted.

In the depicted embodiment, the WOLD 100 is adhered to a pane of glass 202 on an upper window sash 204 of the double-hung window 200. Both the upper 204 and a lower sash 206 are able to slide relative to each other in a frame 208. FIG. 2A depicts a lower window sash 206 in a closed range. In this case, the closed range includes any position of the lower window sash 206 from the completely closed position to a position just prior to a limited position. While the lower sash 206 is in the closed range, the stop 104 extends from the base 102 of the WOLD 100, into the path of travel of the lower window sash 206. In this embodiment, when the stop 104 is in the extended position, the catch 106 is in a rest position. As described above, the stop 104 is biased toward the extended position due to the action of the spring.

FIG. 2B depicts the lower sash 206 in a limited position that is reached when the sash 206 contacts the stop 104. This interaction between the stop 104 with the lower sash 206 effectively prevents further upward movement of the lower sash 206. This distance from a completely closed position to the limited position may be about 4 inches or some other distance, as desired or as dictated by building or safety codes. Ultimately, the limited position will be dependent upon the location of the WOLD 100. To move the lower sash 206 beyond the limited position, a user first forces the stop 104 back into the retracted position, as depicted in FIG. 2C. When the catch 106 is in a first position (as depicted in FIG. 2C), the projection 116 on the catch 106 mates with the stop recess 110, thus holding the stop 104 in the retracted position. Once the stop 104 is placed into the retracted position, the sash 206 may then be opened beyond the level of the stop 104, thus bypassing the WOLD 100. As the sash 206 is moved, a top of the sash 206 contacts the flexible bumper 122, as depicted in FIG. 2D. As the sash 206 is moved further, the force applied on the bumper 122 by the sash 206 causes rotation of the catch 106. As the catch 106 rotates into a second catch position, the projection 116 on the catch 106 disengages from the stop recess 110. Once released, the stop 104 is biased towards the extended position by the spring. Complete extension of the stop 104 is not possible, however, while the sash 206 is proximate the stop 104.

Further movement of the sash 206 causes further pivoting of the catch 106, until the catch 106 reaches its maximum pivoted position. When in the maximum pivoted position, the catch 106 may no longer rotate. As the sash 206 is moved further, the flexible bumper 122 deflects upward, allowing the sash 206 to be moved above the level of the WOLD 100. Lowering the sash 206 automatically resets the WOLD 100. The flexible bumper 122 does not prevent downward movement of the sash 206. Additionally, as the sash 206 contacts the stop 104 while moving downward, engagement between the sash 206 and the surface recess 110 compels pivoting movement of the stop 104 against the biasing force of the spring. This pivots the stop 104 toward the base 102, allowing the sash 206 to be closed. Once the sash 206 is lowered below the limited position, the stop 104 is again projected into the path of the travel of the sash 206, thus reset to prevent subsequent movement of the sash 206 beyond the limited position.

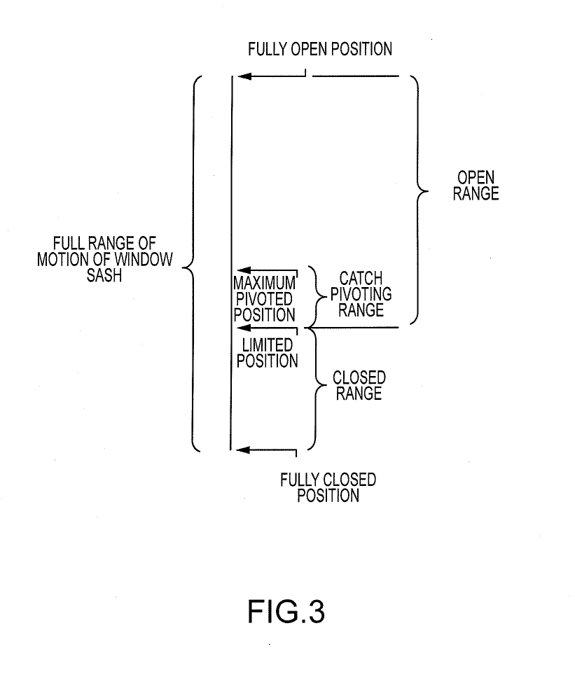

FIG. 3 depicts a schematic side view of the range of motion of a window having a WOLD as described herein. The various positions and ranges are depicted. Notably, the closed range ends at the limited position, where the stop prevents further upward movement of the sash. Once the stop has been moved into the retracted position, the window may be opened into an open range. As the window sash moves further, it moves the catch through a pivoting range, where the catch pivots due to contact between the bumper and the window sash. At the maximum pivot position, the bumper deflects as the window sash is moved further into the open range.

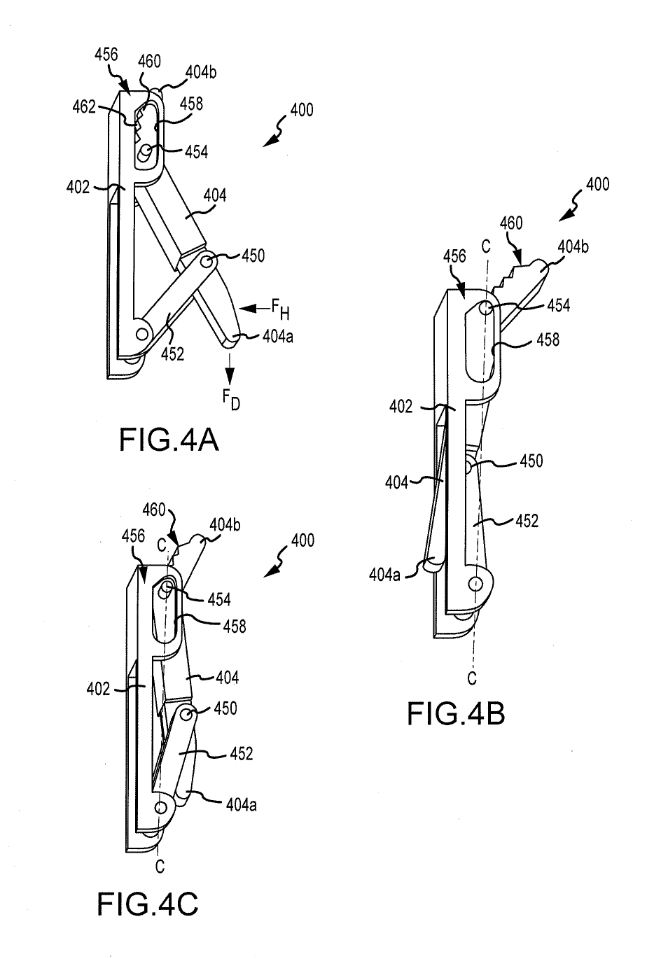

FIGS. 4A-4C are side perspective views of an alternative WOLD 400 in a stop position, a bypass position, and a reset position, respectively. The WOLD 400 includes a base 402 that may be adhered or otherwise secured to a pane of glass, a window sash, or a window frame, as described above. The WOLD 400 includes a stop finger 404 pivotally engaged via a link pin 450 to a link 452 that connects to the base 402. In the depicted embodiment, the link pin 450 is proximate a stop end 404a of the stop finger 404. A guide pin 454 is located proximate a release end 404b of the stop finger 404. The guide pin 454 contacts a wall 456 in the base 402 defining a recess 458 when the stop finger 404 is moved, as described below. When in the stop position depicted in FIG. 4A, the stop end 404a projects away from the base 402 and one or more stop finger notches 460 engage with one or more base notches 462. When these notches 460, 462 are engaged, a corresponding downward force F_{D} is produced against an upward force acting against the stop end 404a (e.g., as by a window sash contacting the stop end 404a). This corresponding downward force F_{D} prevents further movement of the sash. To disengage the WOLD 400, a substantially horizontal force F_{H} is directed against the stop end 404a, for example, by a user. This disengages the stop finger notches 460 and the base notches 462 and moves the stop end 404a towards the base 402. As the stop end 404a moves towards the base 402, the guide pin 454 guides the release end 404b upward, and the link pin 450 moves past a straight pin alignment axis C into a stable position. Once the link pin 450 is in this stable position, the WOLD 400 is in the bypass position, depicted in FIG. 4B. In the bypass position, the release end 404b of the stop finger 404 projects into a path of travel of the window sash. Upon contact between the sash and the release end 404b, the stop finger 404 again pivots around the link pin 450, such that the link pin 450 moves to a position forward of the straight pin alignment axis C. When in this forward position, as depicted in FIG. 4C, further movement of the sash below the level of the stop end 404a causes the sash finger 404 to return to the position where the stop end 404a projects into the path of travel of the window sash and the stop finger notches 460 engage with the base notches 462 (i.e., into the stop position of the WOLD 400, as depicted in FIG. 4A).

It is contemplated that more than one WOLD may be used on a window, typically one on each side of the sash. However, a single WOLD may be utilized if desired. Additionally, multiple WOLDs may be used in conjunction with a window sash, to provide multiple limited positions, as desired for a particular application. Additionally, WOLDs may be secured to both the sash and the frame, for multiple limited positions, for additional security, or for both. The entire WOLD or components thereof may be manufactured by known techniques using injection molded plastics, including PVC, ABS, various grade densities of polyethylene, or other plastics typically used in the fenestration industry. Additionally, the entire WOLD or components thereof may be manufactured of stainless steel, brass, zinc, or other metals. Components described herein, for example, the base and receiver, may be integrally or discretely manufactured.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A window opening limit device comprising:
a substantially planar base;
a sash stop pivotally engaged with the base between a first stop position and a second stop position, wherein the sash stop is adapted to pivot about a first axis substantially parallel to the base; and
a catch pivotally engaged with the base between a first catch position and a second catch position, wherein the sash stop is adapted to pivot about a second axis substantially perpendicular to the base, and wherein when in the first catch position, the catch is engaged with the sash stop, and wherein when in the second catch position, the catch is disengaged from the sash stop.

2. The window opening limit device of claim 1, further comprising a spring for biasing the sash stop towards the second stop position.

3. The window opening limit device of claim 2, wherein when in the second stop position, the sash stop is oriented substantially perpendicular to the base.

4. The window opening limit device of claim 2, wherein when in the second stop position, the sash stop is oriented at an angle to the base.

5. The window opening limit device of claim 1, wherein when in the first stop position, the sash stop is oriented substantially parallel to the base.

6. The window opening limit device of claim 1, further comprising an adhesive secured to a side of the base opposite the catch.

7. The window opening limit device of claim 1, wherein the catch comprises a bumper adapted to pivot the catch from the first catch position to the second catch position, in response to a force exerted against the bumper.

8. A window opening limit device comprising:
a substantially planar base;
a sash stop pivotally engaged with the planar base between a first stop position and a second stop position; and
an adhesive element secured to a side of the base opposite the stop.

9. The window opening limit device of claim 8, wherein when in the second stop position, the sash stop is oriented substantially perpendicular to the base.

10. The window opening limit device of claim 8, wherein when in the second stop position, the sash stop is oriented at an angle to the base.

11. The window opening limit device of claim 8, further comprising:
a catch pivotally engaged with the base and adapted to releasably secure the sash stop in the first stop position when the catch is in a first catch position.

12. The window opening limit device of claim 11, wherein the catch is adapted to disengage from the sash stop when the catch is in a second catch position.

13. The window opening limit device of claim 11, wherein when in the first catch position and the second catch position, the catch is substantially parallel to the base.

14. The window opening limit device of claim 8, further comprising a spring for biasing the stop towards the second stop position.

15. A window comprising:
a first sash comprising a pane of glass and a sash frame at least partially surrounding the pane of glass; and
a window opening limit device secured to the pane of glass.

16. The window of claim 15, wherein the window opening limit device comprises:
a substantially planar base;
a sash stop pivotally engaged with the planar base between a first stop position substantially parallel to the base and a second stop position; and
an adhesive element secured to a side of the base opposite the stop, wherein the adhesive element is secured to the pane of glass.

17. The window of claim 16, wherein the window opening limit device further comprises:
a catch pivotally engaged with the base and adapted to releasably secure the sash stop in the first stop position when the catch is in a first catch position.

18. The window of claim 17, further comprising a second sash slidably movable relative to the first sash, wherein when the sash stop is in the second stop position, the second sash is substantially prevented from movement relative to the first sash.

19. A method of mounting a window opening limit device to a window sash comprising a pane of glass, the method comprising adhering the window opening limit device to the pane of glass.

20. The method of claim 20, wherein the window opening limit device comprises:
a substantially planar base;
a sash stop pivotally engaged with the base between a first stop position and a second stop position; and
an adhesive element secured to a side of the base opposite the stop, wherein the adhesive element secures the base to the pane of glass.
